(19) United States
(12) Patent Application Publication
(10) Pub. No.: US 2014/0254011 A1
(43) Pub. Date: Sep. 11, 2014

(54) FABRICATION OF COATABLE WIRE GRID POLARIZERS

(71) Applicant: RavenBrick, LLC, Denver, CO (US)

(72) Inventors: Wil McCarthy, Lakewood, CO (US); Wilder Iglesias, Louisville, CO (US); Christopher M. Caldwell, Denver, CO (US)

(21) Appl. No.: 14/203,150

(22) Filed: Mar. 10, 2014

Related U.S. Application Data
(60) Provisional application No. 61/775,340, filed on Mar. 8, 2013.

(51) Int. Cl. G02B 5/30; B05D 3/14; B05D 3/00; B05D 5/06

(52) U.S. Cl. CPC G02B 5/3058; B05D 5/06; B05D 3/14; B05D 3/203; B82Y 20/00
USPC 359/485.05; 427/163.1; 427/472; 427/598; 427/595; 977/834

(57) ABSTRACT

A wire grid polarizer formed as a self-assembled coating on a substrate surface. Metal or other conductive nanowires are coated with a transparent dielectric material having a thickness approximately equal to one-half of the desired WGP wire spacing or pitch. A suspension of coated nanowires in a chromonic liquid crystal is shear-coated onto an aligned substrate and dried. The chromonic liquid crystal, a solution of dye molecules and water, forms an orderly structure and induces the nanowires to align with their longitudinal axes parallel to the shear direction and/or alignment direction. The polarizer has a minimum polarizing wavelength determined by an average lateral spacing of nanowire segments. The polarizer has a transmissivity and a contrast ratio determined by the width of the nanowire segments.

### CROSS REFERENCE TO RELATED APPLICATIONS

This application claims the benefit of priority pursuant to 35 U.S.C. §119(e) of U.S. provisional patent application No. 61/775,340 entitled “Fabrication of coatable wire grid polarizers” filed on 8 Mar. 2013, which is hereby incorporated by reference in its entirety for all purposes.

This application is related to U.S. Pat. No. 7,768,693 to McCarthy et al.; U.S. Pat. No. 7,755,829 to Powers et al.; U.S. patent application Ser. No. 13/150,475 filed 1 Jun. 2011 entitled “Multifunctional building component”; U.S. patent application Ser. No. 12/916,233 filed 29 Oct. 2010 entitled “Thermochromic filters and stopband filters for use with same”; and U.S. patent application Ser. No. 13/601,472 filed 31 Aug. 2012 entitled “Thermochromic optical shutter incorporating coatable polarizers”, each of which is hereby incorporated by reference herein in its entirety.

### BACKGROUND

1. Technical Field

The subject matter described herein relates to a method for producing coatable wire grid polarizers. Implementations of such devices have application in passive or active light-regulating and temperature-regulating films, materials and devices, including video displays and construction materials.

2. Description of the Related Art

The problem of controlling the flow of radiant energy, e.g., light and heat, in particular in applications such as regulating solar heat gain in buildings and in other applications has previously been addressed using many optical and infrared methodologies. Photo-darkening materials have been used for decades, for example, in sunglass lenses, to selectively attenuate incoming light when stimulated by ultraviolet (UV) radiation. When incorporated into windows, such materials can be used to regulate the internal temperature of a structure by darkening to attenuate bright sunlight and by becoming transparent again to allow artificial light or diffuse daylight to pass through unimpeded. Such systems are passive and self-regulating, requiring no external signal other than ambient UV light in order to operate. However, because they are controlled by UV light rather than by temperature, such systems are of limited utility in temperature-regulating applications. For example, they may block wanted sunlight in cold weather as well as unwanted sunlight in hot weather. They also may not function if placed behind a UV-blocking material such as the transparent, spectrally-selective and low-emissivity coatings that are commonly employed in the window industry.

U.S. Pat. No. 7,755,829 to Powers et al. discloses an optical filter that can be used as a window film or other light- and heat-regulating building material. The filter is composed of a thermotropic, low clearing point, twisted nematic liquid crystal sandwiched between two reflective polarizers. In addition, U.S. patent application publication no. 2009/0268273 to Powers et al. discloses a thermotropic optical filter incorporating both absorptive and reflective polarizers.

Numerous types of linear polarizers, including absorptive, diffusive, and reflective types made from stretched polymers are known. These polarizer types have existed for many years in the field of polarizing optics, especially liquid crystal optics such as video displays. Linear, reflective, wire grid polarizers are less commonly used but are known. Circular polarizers are made from a coatable film of cholesteric liquid crystals, or CLCs. Thermotropic devices incorporating all of these polarizer types have been disclosed in U.S. Pat. No. 7,755,829 and related patents and patent applications to Powers and McCarthy.

Coatable linear polarizers are also known. For example, in a scientific paper entitled “A novel thin film polarizer from photocurable non-aqueous lyotropic chromonic liquid crystal solutions,” Yun-Ju Bae, Hye-Jin Yang, Seung-Han Shin, Kwang-Un Jeong and Myong-Hoon Lee, (J. Mater. Chem., 2011, 21, 2074), Korean researchers Bae et al. disclose a composition of matter which, when shear-coated and UV cured onto a glass surface, forms a thin-film polarizer. Shear may be induced by a number of different coating processes, including doctor blade coating, Mayer rod coating, roll coating, and gravure coating. Such processes are well described, including for example in U.S. Patent 2002/0160296 to Wolk et al.

These shear-coated linear polarizers typically consist of lyotropic, chromonic liquid crystals (LCLCs), which are essentially dye molecules that have been functionalized so they behave as liquid crystals. These materials may not be commercially available but may be prepared using common synthetic organic chemistry techniques. In the base of Bae et al., the LCLC was mixed with a prepolymer material and then cured to form a polymer matrix with LCLC interspersed, providing increased mechanical stability to the system. These coatings are typically applied to either glass or thin film polymer substrates.

Coatable polarizers made from chromonic liquid crystal polymers are also disclosed for example in U.S. Pat. No. 6,673,398 to Schneider et al., U.S. Pat. No. 7,294,370 to Lavrentovich et. al., and U.S. Pat. No. 6,541,185 to Matsunaga et. al, and in patent applications US2009/0153781 to Otani et. al., and US2011/0017949 to Golovin et. al., and in international patent application number WO2010/096310 to Sahouani et. al.

The article “Aligned Layers of Silver Nano-Fibers,” Andrii B. Golovin, Jeremy Stromer, Liubov Kreminska (Materials 2012, 5, 239-247) teaches an additional technique that involves adding conductive nanowires or nanorods to the chromonic liquid crystal. Metal nanowires and nanorods are well known to absorb light at particular wavelengths through a phenomenon known as surface plasmon resonance (SPR), wherein the energy of the absorbed photon is equal to the energy of an AC standing wave, or plasmon, trapped at the surface of the metal. Generally there will be an absorption peak centered around the plasmon energy, with a certain bandwidth surrounding it that depends on the aspect ratio of the nanowire or nanorod. In fact there are two absorption peaks: a strong one driven by the longitudinal plasmon energy, and a weaker one driven by the transverse plasmon energy. Thus, depending on their aspect ratio and composition (in this case, silver), these metal nanoparticles absorb photons within a predictable range of wavelengths.

Furthermore, when mutually aligned along their longitudinal axes, these nanoparticles exhibit a polarizing effect across the absorbed wavelengths. Therefore, when a suspension of the nanoparticles is mixed into a chromonic liquid crystal, such as a 1-3% solution of IR-806 dye in water, shear-coated onto a surface and then allowed to dry into a solid film, the LC provides alignment to the nanowires or nanorods, inducing them to form an absorptive polarizing structure.

The information included in this Background section of the specification, including any references cited herein and any description or discussion thereof, is included for technical reference purposes only and is not to be regarded subject matter by which the scope of the invention as defined in the claims is to be bound.

### SUMMARY

In one exemplary implementation, a wire grid polarizer (WGP) is formed as an ordered, self-assembled coating on a substrate surface. Like an ordinary WGP, this structure is capable of reflecting light of one polarization and transmitting light of an orthogonal polarization. However, whereas traditional WGPs are formed through a lithography step (whether photolithography, nanoimprint lithography, or some other method), a metallization step, and possibly a stripping step, the self-assembled polarizer disclosed herein is formed from metal nanowires coated with a transparent dielectric material having a thickness approximately equal to one-half of the desired WGP wire spacing or pitch. A suspension of these coated nanowires in a chromonic liquid crystal is shear-coated onto an aligned substrate and then allowed to dry. The chromonic liquid crystal, itself a solution of dye molecules and water, forms an orderly structure and induces the nanowires to align with their longitudinal axes parallel to the shear direction and/or alignment direction. This orientation is then retained when the water evaporates, leaving behind a structure that closely resembles a traditional WGP, except that instead of a plurality of continuous metal wires extending in parallel from one side of the substrate to the other, the structure is formed of a plurality of wire segments whose width and spacing may be similar to those of a traditional WGP, but whose lengths are those of the nanowire segments, typically in the range of 10-100 microns.

When these wire segments are too long to form effective plasmon resonators, they do not absorb radiation along their longitudinal axes, and as their length is increased they will therefore behave more like the long, continuous wires of a WGP and less like the absorptive plasmon resonators. In other words, above a certain threshold length, these wire segments will reflect light within a given range of wavelengths rather than absorbing it. However, it should be noted that the transverse axis may have dimensions such that plasmon resonance occurs within the visible or NIR wavelengths. In this case, both the absorption and the reflection will be highly polarized, as they rely on direct conduction of AC currents along the surface of the metal. However, the reflection will generally occur for photons having a polarization that is parallel to the wires, whereas the transverse plasmon absorption (if any) will generally occur for photons of a shorter wavelength or range of wavelengths having a polarization that is perpendicular to the wires.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1 is a schematic representation of a thermotropic, liquid crystal-based, optical filter.

FIG. 2 is a schematic representation of a polarizer coating applied to a substrate material.

FIG. 3 is a schematic representation of a single coated nanowire.

FIG. 4 is a schematic representation of an exemplary shear-coated monolayer of coated nanowires.

FIG. 5 is a photograph of a “log jam” wherein cut logs being floated downriver (analogous to metal nanowires in a sheared liquid) exhibit a density too high to form only a monolayer on the surface of the river.

FIG. 6 is a photograph of a monolayer of cut logs floating downriver in orderly raft structures.

FIG. 7 is a notional polarization spectrum for an exemplary implementation of a polarizer formed of coated nanowires.

### DETAILED DESCRIPTION

Wire grid polarizers (WGPs) are available that operate in the visible and NIR wavelengths and (unlike the dispersed nanowire polarizer described by Golovin et al.) reject light of a certain polarization through reflection rather than absorption. (It should be noted that the term “wire grid polarizer”, while widely employed in the art, is actually a misnomer since the polarizing structures in question are technically wire gratings rather than grids. Therefore, for the purposes of this document, a reference to a “wire grid polarizer” actually refers to a structure in the form of a grating.) The WGP concept was first described in 1888, and has since been detailed in numerous textbooks on optics, liquid crystals, and video displays. There is even commercial software available for computing the properties of a WGP based on its geometry. The white paper, “Wire Grid Polarizers: a New High Contrast Polarizer Technology for Liquid Crystal Displays” by Agoura Technologies and available on the company's website <http://www.agouratech.com/TechnologyWP.pdf, last visited Mar. 8, 2013>, provides a compact overview of WGP technology over the past 120 years.

There are numerous other publications that disclose structures designed to polarize visible light and NIR. For example, U.S. Pat. No. 6,081,376 to Hansen et al. discloses “a generally parallel arrangement of a plurality of thin, elongated, spaced-apart elements” (i.e., a grating of wires) with a periodic spacing smaller than a wavelength of light, that “transmit light having a polarization orientation perpendicular to the elements and . . . defining reflect light having a polarization orientation parallel with the elements.” As with other WGP structures, the minimum wavelength that the structure of Hansen et al. can polarize is a direct function of the spacing of the wires. However, above this minimum wavelength the polarization efficiency rises rapidly, and remains so for wavelengths that are many multiples of the minimum.

It is not unusual for a WGP to polarize across the entire visible and NIR spectrum. As a general rule of thumb for a given wire pitch or spacing P, the polarizer is capable of polarizing wavelengths equal to or larger than ˜3P. The width of the individual wires then defines a “fill factor” (i.e., the fraction of the surface actually covered by metal), with higher fill factors generally associated with higher contrast ratios and lower light transmission levels, and lower fill factors generally associated with lower contrast ratios and higher light transmission levels, such that for a given pitch and resultant polarizing bandwidth, the fill factor can be adjusted by varying the thickness of the wires, to yield a desired balance between contrast and transmissivity.

Thermotropic optical shutters incorporating polarizing films are useful as energy-regulating building materials, including “smart” window films that tint when heated. However, as disclosed, for example, in U.S. Patent Application Publication No. 2011/0102878, it may be desirable to vary the absorptivity, reflectivity, diffusivity, polarizing efficiency, contrast ratio, visible light transmission, or bandwidth of one or more polarizers incorporated into such devices. Changes in the aforementioned properties of the thermochromic window filter may lead to performance enhancements including increased light transmission, larger “throw” (i.e., variance in the solar heat gain coefficient) to allow more solar heat to be blocked or transmitted, and changing the way the filter blocks said radiation by either absorbing, reflecting or diffusing the light thus altering its properties and appearance. As noted in the reference, in many cases the ideal polarizer for such thermochromic filters may be one that blocks solar NIR wavelengths via reflection (the most efficient way to reject solar heat gain) and that blocks visible light wavelengths via absorption (the option most likely to comply with glare ordinances in local municipalities).

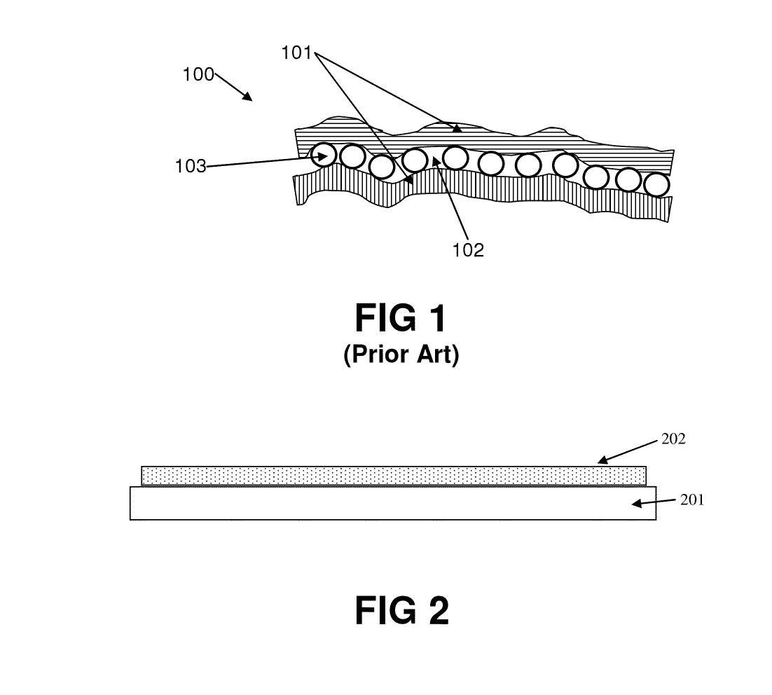

FIG. 1 is from the prior art (U.S. Patent Application Publication No. 2010/0045924 to Powers et. al.) and is a schematic representation of a thermotropic, liquid crystal-based, optical filter 100. The space between the substrate materials 101 (e.g., the polarizing films) is filled with a mixture of liquid crystal 102 and spacers 103. The spacers 103 in this design are microscopic, spherical, and have a small variance in size, providing a uniform cell gap between the substrate materials 101, such that the optical properties of the liquid crystal 102 do not vary in undesirable ways with location.

FIG. 2 is a schematic representation of a polarizer coating applied to a substrate. A transparent or translucent substrate material 101 (e.g., a polymer film) is coated with a thin layer of coatable polarizer 102.

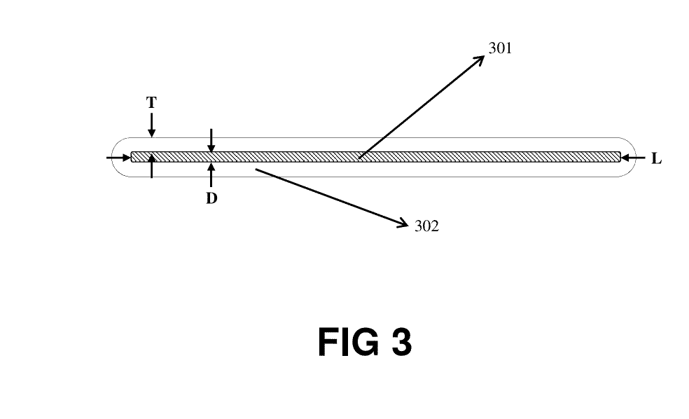

FIG. 3 is a schematic representation of a single nanowire of length L and diameter D, coated with a layer of transparent polymer or other transparent dielectric material of thickness T. Such coated nanowires are most typically made of silver, are well described in the prior art, may be mass-produced with high uniformity and polydispersity through a chemical process, and are available commercially from suppliers such as NANOGAP, NanoTech Labs, and Seashell Technologies. Metal nanowires and nanorods are well known to absorb light at particular wavelengths through surface plasmon resonance (SPR). In fact there are two absorption peaks: a strong one driven by the longitudinal plasmon energy, and a weaker one driven by the transverse plasmon energy.

“Simulation of the Optical Absorption Spectra of Gold Nanorods as a Function of Their Aspect Ratio and the Effect of the Medium Dielectric Constant” (S. Link, M. B. Mohamed, and M. A. El-Sayed, J. Phys. Chem. B 1999, 103, 3073-3077) describes the relationship between the nanowire geometry and the peak absorption wavelength for gold, which can be summarized with the following equation, included here for exemplary rather than limiting purposes since empirical results may vary significantly based on a variety of factors:

λ=(33.34*(L/D)−46.31)*εₘ+472.31,

where λ is the peak absorption wavelength, L is the length of the nanowire, D is the diameter of the nanowire, and εₘ is the dielectric constant of the surrounding medium (e.g., air, water, or a polymer in which the nanowire is embedded).

In general, nanorods or nanowires with aspect ratios greater than 15:1 will exhibit a longitudinal SPR in the mid-infrared (MIR) with a wavelength of 2000 nanometers or more. This is longer than the UV, visible, and near-infrared (NIR) wavelengths associated with sunlight and, for long wires with aspect ratios of 100 or more, the longitudinal plasmon energy is negligible and the peak absorption wavelength is completely outside the infrared band (i.e., in the microwave or radio bands). However, as the length of the wires increase, it can increasingly be considered a macroscopic electrical conductor, such that it may be highly reflective to radiation having a polarization that is parallel to the longitudinal axis. Indeed, while suspensions of short silver nanorods in a liquid or solid may have a strong color, indicating the presence of absorption peaks in or near the visible wavelengths, longer nanowires with high aspect ratio will typically have a metallic (i.e., reflective) appearance.

In addition, a transverse plasmon will generally occur at lower intensity at a shorter wavelength, which for certain aspect ratios may coincide with the visible spectrum. In this case, it is possible to have a nanowire wire that reflects NIR photons with polarization parallel to the longitudinal axis and absorbs visible photons with polarization parallel to the transverse axis. In a preferred embodiment of the present invention, nanowires meeting this description are employed.

The nanowires are additionally coated with a layer of transparent polymer or other dielectric with a thickness T, such that the nanowires cannot contact one another and cannot get any closer together than 2T. This permits a uniform minimum spacing in any self-assembled film or other structure containing the nanowires. This coating differentiates the present technology from the polarizing device or structure defined by Golovin et al., which is not capable of acting as a wire grid polarizer because there is no mechanism for controlling the spacing of the nanowires such that they form a regular grating, or from contacting one another and “shorting out”.

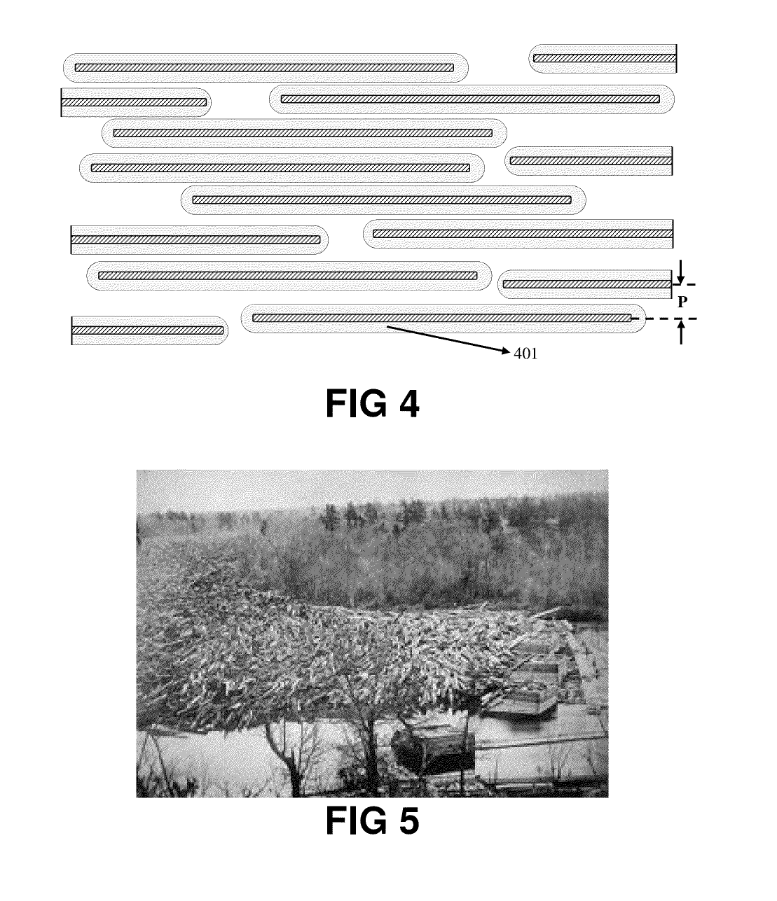

FIG. 4 is a schematic representation of an exemplary self-assembled monolayer of coated nanowires. The nanowires are suspended in a solution of chromonic liquid crystal consisting of one or more solvents and one or more dyes or other chromonic substances capable of forming a nematic liquid crystal phase in solution. The nanowires in solution may be either shear-coated onto a non-aligned surface or may be coated by any method (whether shearing or otherwise) onto a liquid crystal alignment layer. The nematic structure of the chromonic liquid crystal aligns the nanowires with their long axes pointing in the shear direction (or, alternatively, in the alignment layer direction), which is preserved when the solvent in the chromonic liquid crystal is evaporated.

In an exemplary implemenation, the chromonic liquid crystal may be a 3% wt solution of cromolyn in water and the nanowires may be composed of silver, have diameter 100 nm and a length 30 μm, may be coated with a transparent layer of polyamide at a thickness of 100 nm, and may be suspended within the chromonic liquid crystal at 2% vol.

The substrate area that is covered by a single coated nanowire can be closely approximated as

A_{single}=(D+2T)*(L+2T).

The maximum density of wires in a monolayer of area A occurs when N*A_{single}=A, where N is the number of nanowires within area A. In the exemplary embodiment discussed above, for wires of diameter 0.1 μm and length 30 μm, coated by a transparent polymer of thickness 0.1 μm, the area of a single coated wire is 9 μm² or 9E⁻⁶ mm². The maximum density of the wires in a monolayer is therefore N=1/9E⁻⁶=111,111 wires per mm².

However, such density requires a theoretically optimal monolayer wherein the nanowires fit together perfectly, leaving no empty space. Allowing room for slightly suboptimal placement and alignment of the nanowire segments, as well as room for the cromolyn molecules that provide alignment, we can approximate the maximum density at N=100,000 wires per mm². Concentrations lower than this may tend to form a monolayer as this is energetically favorable (particularly when the nanowires are all aligned along the same director), whereas higher concentrations than this may tend to form multiple layers, which may be undesirable. Since the LC/nanowire suspension is 2% nanowires by volume, the maximum wet coating thickness M for monolayer formation would be (D+2T)/0.02=15 μm.

Once the coating is dried, the average pitch or period P of the resulting wire grating would be slightly larger than D+2T, or 300 nm, forming a WGP with a minimum polarizing wavelength of 3P or approximately 900 nm. In other words, the WGP would be effective for infrared wavelengths of 900 nm and longer with a theoretical maximum contrast ratio of >100:1, and would exhibit a roll-off in polarization efficiency and contrast ratio between 900 nm and 700 nm, and would exhibit little or no polarization in the visible and ultraviolet wavelengths. These numbers are supplied for exemplary purposes only.

It may also be noted that for densities approaching but not exceeding N, it is energetically favorable for the nanowires to assume a more or less parallel alignment. In essence, like a plurality of cut logs floating on a river they will prefer to “fall” into this orderly configuration rather than stacking on top of one another. However, if the order parameter of the chromonic liquid crystal/nanowire mixture (i.e., the degree of alignment uniformity as the mixture is coated and dried) is significantly lower than 1 or the density is greater than N, this will increase the chance of any given nanowire misaligning with respect to its peers and therefore stacking on top rather than forming a monolayer. Thus, mixtures with appropriate density, good alignment, and a high order parameter will “fall” into even better alignment, whereas those with poor alignment or high density may not benefit from this effect. This phenomenon is noted in passing and for exemplary purposes only.

In the same exemplary embodiment discussed above, the substrate may be a polyamide material (or may be coated with a polyamide) that has been rubbed in a desired direction (e.g., parallel to the downweb direction of the roll) to produce a liquid crystal alignment layer of a sort well known and described. The nematic suspension of water, cromolyn, and coated silver nanowires may then be applied to the surface using a Mayer rod to lay down a wet coating of uniform thickness of less than M. The chromonic liquid crystal then aligns nematically according to the polyamide alignment layer, and provides a director to the coated nanowires. The director is retained as the water evaporates and the wet coating loses roughly 95-98% of its volume, leaving behind a solid film of cromolyn and coated nanowires. An electric or magnetic field may optionally be employed to further enhance the alignment of the nanowires. In the exemplary embodiment, this solid film may then be overcoated with a passivating layer of polyamide to prevent nanowires from breaking loose from the surface.

FIG. 5 is a photograph of a “log jam” wherein cut logs being floated downriver (analogous to metal nanowires in a sheared liquid) exhibit a density too high to form a monolayer on the surface of the river. A natural alignment mechanism is supplied by the shearing force of the river current, which tends to align the longitudinal axis of a log with the direction of the current. However, in this case the high particle density overwhelms this self-organization, and the order parameter of the resulting structure is poor.

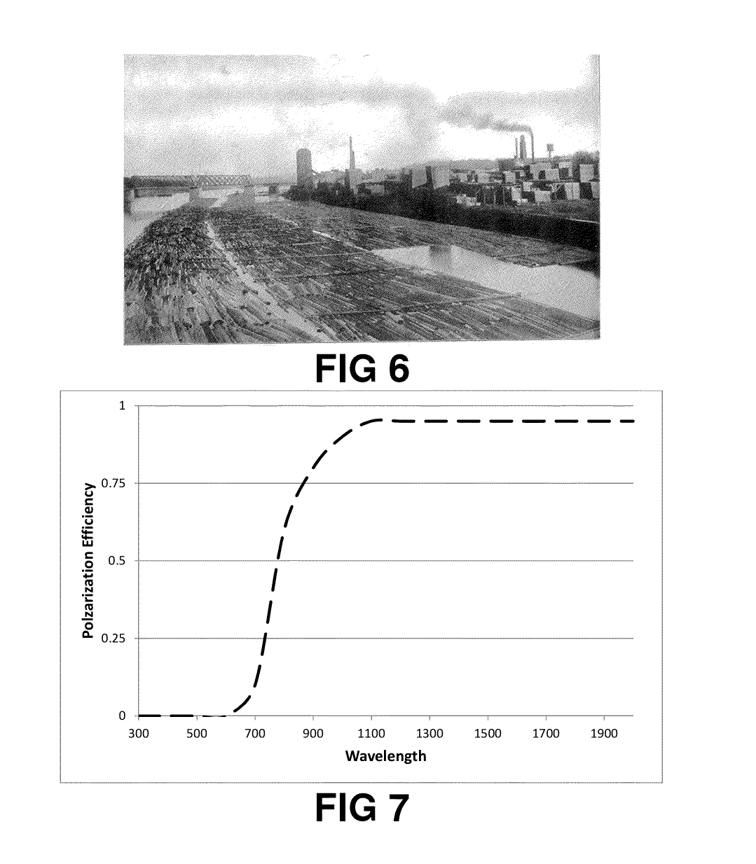

FIG. 6 is a photograph of cut logs floating downriver in orderly raft structures. In this case, the log density is low enough to form a monolayer over part of the river, and additional structures (transverse wooden beams, analogous to the columnar structures formed by cromolyn) help enforce the alignment. The combination of monolayer formation, dense packing, shearing force from the river current, and additional alignment structures create an extremely orderly, self-assembled structure with high order parameter. If the logs were electrically conductive and coated with transparent polymer to enforce minimum spacing, this structure would be highly analogous to the WGP disclosed herein, and in fact would function as a WGP for radio wavelengths equal to or longer than 3×the log spacing. It may be noted that the logs could still form orderly structures even without the transverse beams.

FIG. 7 is a notional polarization spectrum based on the exemplary embodiment of the coatable WGP described above.

Numerous variations on the exemplary process described above may be employed. For example, the fill factor of the WGP could be different, with smaller fill factors generally resulting in higher light transmission, and larger fill factors generally resulting in higher contrast ratio. The wet coating could be applied by a roll coater, gravure coater, doctor blade, or other coating apparatus and, in the case of a gravure or doctor blade process, the shear applied to the film may reduce or eliminate the need for a rubbed alignment layer. For example, typical aligned chromonic coatings (whether incorporating metallic nanoparticles or not) are generally aligned by shearing on a glass substrate, with no need for a rubbed alignment layer. Furthermore, surface wetting may optionally be enhanced through corona treatment or sodium hydroxide treatment, and evaporation speed may be increased by applying heat and/or convection, or by including a small amount of high-vapor-pressure solvent such as IPA in the liquid crystal solution.

The order parameter of the chromonic liquid crystal may also be improved through the addition of dopants (including, for example, but not limited to, the block copolymer PDMS:PEO and the dye Fast Violet B) typically, though not exclusively, in concentrations less than 2% wt. It is believed that many chromonic dyes can serve as alignment-enhancing dopants, provided their molecular weights are within one order of magnitude of the molecular weight of the chromonic LC material.

The nanowires and dielectric coating may also be of different dimensions and different materials than those noted in the exemplary implementations described herein to produce different optical effects. The mixture may incorporate nanowires of multiple lengths and even multiple diameters and coating thicknesses in order to achieve metameric blending of multiple strong, narrow absorption or reflection peaks into a relatively flat spectral response. The passivating overcoat may be of a different material or may be deleted altogether, without altering the functioning of the nanowire monolayer as a wire grid polarizer.

The alignment layer may be a rubbed polymer as described above, but may also be composed of some other rubbed material or indeed any formed or deposited material having a natural self-alignment properties that cause it to serve as an alignment layer for liquid crystal molecules.

In one implementation, two or more layers of WGP may be formed at different angles with respect to each other, so that two or more polarizations of light may be rejected. In the limiting case where two orthogonal wire gratings are laid down on top of one another, the resultant structure is a grid and will reflect the vast majority of incident radiation of wavelength greater than 3*(D+2T).

In addition, while cromolyn has the useful property of being transparent, i.e., no strong absorption bands in the visible or NIR spectrum, a chromonic liquid crystal by itself, without nanowires or nanorods, can form an absorptive polarizer when shear-coated onto a surface. In the case of cromolyn, any such polarization will occur invisibly in the UV wavelengths which, in a window film application, will typically be blocked in any case. However, other chromonic materials may be used instead and many of these (such as the dyes Violet 20, Blue 27, Direct Blue 67, Cyanine, Sunset Yellow, Methyl Orange, Acid Orange 2, Sirius Supra Brown RLL, Direct Brown 202, Acid Red 14, Acid Red 151, Acid Red 266, Red 2304, Red 2416, Direct Red 1, Direct Red 28, Reactive Red 3:1, Quinacrine, RU31156, and the greenish infrared dye IR-806) show strong absorption in the visible and NIR wavelengths, which may be difficult to distinguish from absorption occurring in the nanorods or nanowires themselves. In another exemplary implementation, within the wavelengths range or ranges of concern, the hue and polarization effects of the chromonic material may be either invisible or negligible or both, such that the chromonic liquid crystal is employed solely to align the nanowire segments and not for its own polarization capabilities.

Nevertheless, for many applications it may be advantageous to use such visibly tinted chromonic molecules, or a blended solution of multiple chromonic species. It may even be possible to form a nematic liquid crystal from the suspension of coated nanorods or nanowires alone, or from chemically functionalized versions thereof. In this case, the nanowire or nanorod mixture is itself a chromonic liquid crystal and may require no other chromonic additive such as cromolyn or IR-806. The nanowires may also be made from nonmetallic electrical conductors such as polyacetylene or carbon nanotubes, so long as they can be similarly overcoated with transparent dielectric or otherwise functionalized to control their spacing within the monolayer.

Finally, the transparent dielectric coating may be replaced with some alternate mechanism for ensuring the proper spacing of the nanowires. For example, the wires could be covered with electrically insulating “spines” of length T, or with dielectric end caps forming a “barbell” or “cotton swab” shape, or with center caps forming a “wrapped bar” shape. Alternatively, an electric charge or phobic coating could be applied such that the nanowires tend to repel one another and naturally self-assemble with a predictable spacing. The nanowires could also be arranged using lasers, interference patterns, photomasks that create “trough” locations where nanoparticles are preferentially drawn and “peak” areas where nanoparticles are preferentially repelled, or with a periodic magnetic field supplied, for example, by a micropatterned template of ferromagnetic material or a periodic electric field supplied, for example, by a conventional wire grid polarizer in close proximity to the coated surface with a voltage applied across it.

In general then, the grated polarizer structure disclosed herein is formed using a coating liquid that incorporates conductive nanowires long enough to have predominantly reflective rather than absorptive properties in the wavelengths of concern along their longitudinal axes, a method or structure to align the conductive nanowires along a desired director, a method or structure to control the spacing between wires, and a method or structure to induce the wires to self-assemble into a monolayer that forms a grating capable of behaving as a wire grid polarizer. Finally, the grated polarizer thus formed may be dried or otherwise acted upon to remove the liquid from the material such that it forms a solid coating.

Several exemplary benefits may be realized by one or more of the exemplary implementations described herein. For example, infrared light may be rejected by the grated polarizer structure thus formed via reflection, thereby maximizing HVAC energy savings in hot weather. The grated polarizer structure may allow visible light to be rejected via absorption, thereby minimizing possible building code violations and/or neighborhood glare complaints The grated polarizer structure may allow thermochromic filters (e.g., for smart windows) to exhibit larger “throw” and lower cost than is possible with traditional absorptive polarizers. The grated polarizer structure may also provide a way to allow the alteration of polarizer properties by varying the dimensions of the metal nanowires and/or the thickness of the dielectric coating applied to them. Further the self-assembled grated polarizer structure may permit mass production of polarizers by ordinary “roll coating” providers who lack the capability to make stretched PVA polarizers or WGPs.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A wire grid polarizer device comprising
a transparent or translucent substrate;
a plurality of conductive nanowire segments having sufficient length and aspect ratio to be predominantly reflective rather than absorptive along a respective longitudinal axis of each nanowire segment for a given range of wavelengths and provided in a solute concentration selected such that the nanowire segments form a monolayer when a solution of the nanowire segments is deposited on the substrate;
a material or structure that aligns the longitudinal axes of the nanowire segments along a specified director as the nanowire segments are deposited onto the substrate; and
a transparent material or structure that controls a spacing between adjacent nanowire segments when the nanowire segments are aligned on the substrate; wherein
the plurality of nanowire segments forms a regular grating configured as a wire grid polarizer for a range of wavelengths specified by a pitch or period of the regular grating.

2. The device of claim 1, wherein the nanowire segments are composed of metal.

3. The device of claim 1, wherein the nanowire segments are composed of nonmetallic conductive material.

4. The device of claim 1, wherein material or structure that aligns the longitudinal axes of the nanowire segments comprises a nematic, chromonic liquid crystal.

5. The device of claim 1, wherein the material or structure that controls the spacing of the nanowire segments comprises a layer of transparent dielectric material surrounding each nanowire segment.

6. The device of claim 1, wherein a diameter and the aspect ratio of the nanowire segments are configured to provide for a transverse plasmon resonance of the device that is capable of absorbing photons at a second specified range of wavelengths.

7. The device of claim 1 further comprising a second regular grating of nanowire segments coated on top of the device; wherein
an orientation of longitudinal axes of the second regular grating of nanowire segments is along a second director in different direction from an orientation of the specified director; whereby the device is configured to reflect light of two or more polarizations.

8. The device of claim 7, wherein the second director and the specified director are orthogonal and the device is thereby configured to reflect a majority of incident light above a threshold wavelength specified by the pitch or period of the grating and a second pitch or second period of the second regular grating.

9. A wire grid polarizer device comprising
a plurality of conductive nanowire segments having sufficient length and aspect ratio to be predominantly reflective rather than absorptive along a respective longitudinal axis of each nanowire segment for a given range of wavelengths and provided in a solute concentration selected such that the nanowire segments form a monolayer when a solution of the nanowire segments is deposited on the substrate;
a transparent or translucent substrate;
a means for aligning the longitudinal axes of the nanowire segments along a specified director as the nanowire segments are deposited onto the substrate;
a transparent means to control a spacing between adjacent nanowire segments when the nanowire segments are aligned on the substrate; and
the plurality of nanowire segments forms a regular grating configured as a wire grid polarizer for a range of wavelengths specified by a pitch or period of the regular grating.

10. The device of claim 9, wherein the means for aligning the nanowire segments comprises one or more of the following: a shear coating of the nanowire segments on the substrate, an electric field, a magnetic field, an electromagnetic field, or a rubbed or formed or deposited liquid crystal alignment layer on the substrate.

11. A method for forming a wire grid polarizer comprising
suspending or dissolving a plurality of nanowire segments in a liquid that collectively along with the nanowire segments exhibits an ordered nematic phase, wherein the nanowire segments each have a sufficient length and an aspect ratio to be predominantly reflective rather than absorptive along a respective longitudinal axis of each nanowire segment for a given range of wavelengths;
supplying a director to the liquid;
aligning the nanowire segments with the director with longitudinal axes parallel;
depositing the suspension or solution onto a transparent or translucent substrate;
controlling a spacing between adjacent nanowire segments as they are deposited onto the substrate;
coating the suspension or solution on the substrate at a thickness and concentration configured for energy favorability of the spaced, aligned nanowire segments to form a monolayer; and
drying or otherwise removing the liquid from suspension or solution such that a solid coating forms on the substrate that preserves the alignment of and spacing between the nanowire segments.

12. The method of claim 11, wherein the nanowire segments are composed of metal.

13. The method of claim 11, wherein the nanowire segments are composed of nonmetallic conductive material.

14. The method of claim 11, wherein the step of controlling the spacing of the nanowire segments comprises surrounding each nanowire segment with a layer of a transparent dielectric.

15. The method of claim 11, wherein the step of aligning the nanowire segments comprises one or more of the following methods:
shear coating the nanowire segments on the substrate;
applying an electric field to the nanowire segments on the substrate;
applying a magnetic field to the nanowire segments on the substrate;
applying an electromagnetic field to the nanowire segments on the substrate; or
rubbing, forming, or deposited a liquid crystal alignment layer on the substrate.

16. The method of claim 11, wherein a diameter and the aspect ratio of the nanowire segments are configured to provide for a transverse plasmon resonance of the wire grid polarizer that is capable of absorbing photons at a second specified range of wavelengths.

17. The method of claim 11, wherein the coating operation forms two or more monolayers on the substrate.

18. The method of claim 11 further comprising
forming a second wire grid polarizer having a second director on top of a first wire grid polarizer having a first director, each wire grid polarizer formed according to the steps above; and
orienting the second director in a different direction from an orientation of the first director to reflect light of two or more polarizations.

19. The method of claim 18 wherein the orienting operation further comprises orienting the first director and the second director orthogonally to reflect a majority of incident light above a threshold wavelength specified by a first pitch or first period of a grating of the first wire grid polarizer and and a second pitch or second period of the second wire grid polarizer.
